(19) United States
(12) Patent Application Publication
(10) Pub. No.: US 2018/0339651 A1
(43) Pub. Date: Nov. 29, 2018

(54) VEHICLE LIGHTING SYSTEM WITH DIRECTIONAL CONTROL

(71) Applicant: Ford Global Technologies, LLC, Dearborn, MI (US)

(72) Inventors: Stuart C. Salter, White Lake, MI (US); Paul Kenneth Dellock, Northville, MI (US); Pietro Buttolo, Dearborn Heights, MI (US); Jeffrey Singer, Plymouth, MI (US); James J. Surman, Clinton Township, MI (US)

(73) Assignee: Ford Global Technologies, LLC

(21) Appl. No.: 15/606,218

(22) Filed: May 26, 2017

(51) Int. Cl. B60Q 3/80; B60Q 3/54; F21V 14/02; F21V 23/04; B60Q 3/76

(52) U.S. Cl. CPC B60Q 3/80; B60Q 3/54; F21V 14/02; B60Q 3/225; B60Q 3/76; B60Q 2500/10; B60Q 2400/40; F21V 23/0471

(57) ABSTRACT

A vehicle lighting apparatus is disclosed. The apparatus comprises a positioning apparatus configured to provide multi axis motion and a light source configured to output an emission in connection with the apparatus. The apparatus further comprises a light controller in communication with the positioning apparatus and the light source. The light controller is configured to control the positioning apparatus to orient the light source directing the emission to a location in the vehicle.

### FIELD OF THE DISCLOSURE

The present disclosure generally relates to vehicle lighting, and more particularly to directional interior vehicle lighting.

### BACKGROUND OF THE DISCLOSURE

Some lighting devices require a user interaction that is not intuitive. Accordingly, interaction with such sensors can be distracting. The disclosure provides for a lighting system to improve on various systems presently available.

### SUMMARY OF THE DISCLOSURE

According to one aspect of the present disclosure, a vehicle lighting apparatus is disclosed. The apparatus comprises a positioning apparatus configured to provide multi axis motion and a light source configured to output an emission in connection with the apparatus. The apparatus further comprises a light controller in communication with the positioning apparatus and the light source. The light controller is configured to control the positioning apparatus to orient the light source directing the emission to a location in the vehicle.

According to another aspect of the present disclosure, a vehicle lighting apparatus is disclosed. The apparatus comprises a positioning apparatus comprising at least one motor configured to provide multi axis motion and a light source configured to output a directional emission in connection with the positioning apparatus. The controller is in communication with the positioning apparatus and the light source. The controller is configured to control the positioning apparatus orienting the light source and directing the emission to a location in the vehicle.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a projected view of a vehicle interior demonstrating a lighting apparatus;

FIG. 2 is a projected view of a headliner of a vehicle comprising a user interface of a lighting apparatus;

FIG. 3 is a of a schematic diagram of a passenger compartment of a vehicle demonstrating an operation of a lighting apparatus;

FIG. 4 is a projected view of a vehicle demonstrating an access light configuration of a lighting apparatus;

FIG. 5 is a projected view demonstrating a storage compartment comprising a luminescent portion configured to illuminate in response to receiving an excitation emission from a light source of a lighting apparatus;

FIG. 6 is a projected view of a positioning apparatus of a lighting apparatus; and

FIG. 7 is a block diagram of the lighting apparatus in accordance with the disclosure.

### DETAILED DESCRIPTION OF THE PREFERRED EMBODIMENTS

As required, detailed embodiments of the present disclosure are disclosed herein.

However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

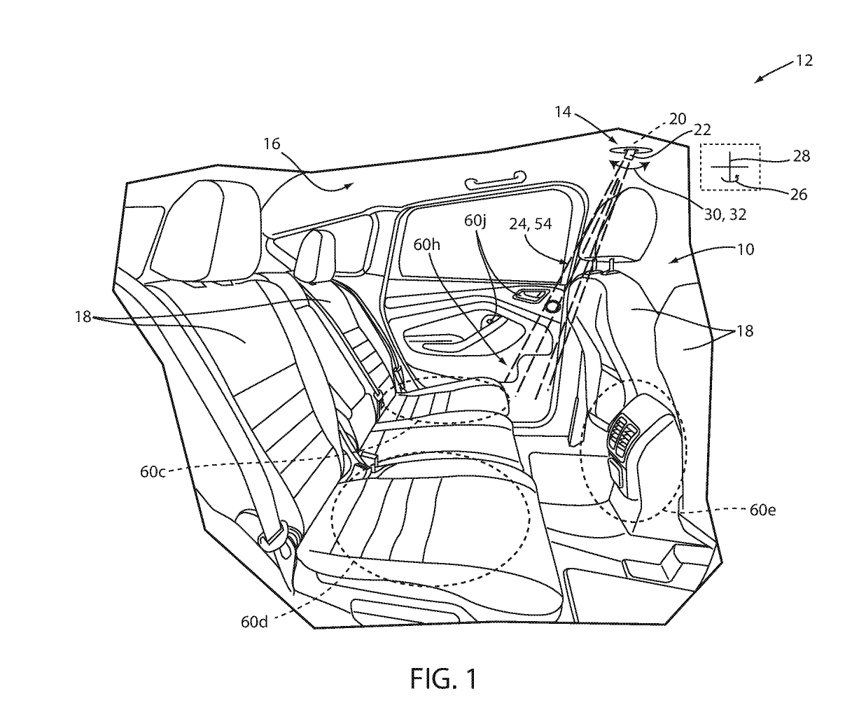

Referring to FIG. 1, a vehicle passenger compartment 10 or cabin of an automotive vehicle 12 is generally illustrated comprising a lighting apparatus 14. The lighting apparatus 14 may be disposed in an overhead console or headliner 16 of the vehicle 12. In the illustrated embodiment, the lighting apparatus 14 may be located centrally in the headliner 16 relative to a plurality of passenger seats 18 within the passenger compartment 10. In an exemplary embodiment, the lighting apparatus 14 may comprise a positioning apparatus 20, which may be configured to rotate and pivot a light source 22 of the apparatus 14 to steer a lighting emission 24 projected from the light source 22. Accordingly, in an exemplary embodiment, the disclosure provides for a lighting apparatus 14 configured to control a positioning apparatus 20 and the light source 22 to illuminate a variety of locations within or proximate to the passenger compartment 10.

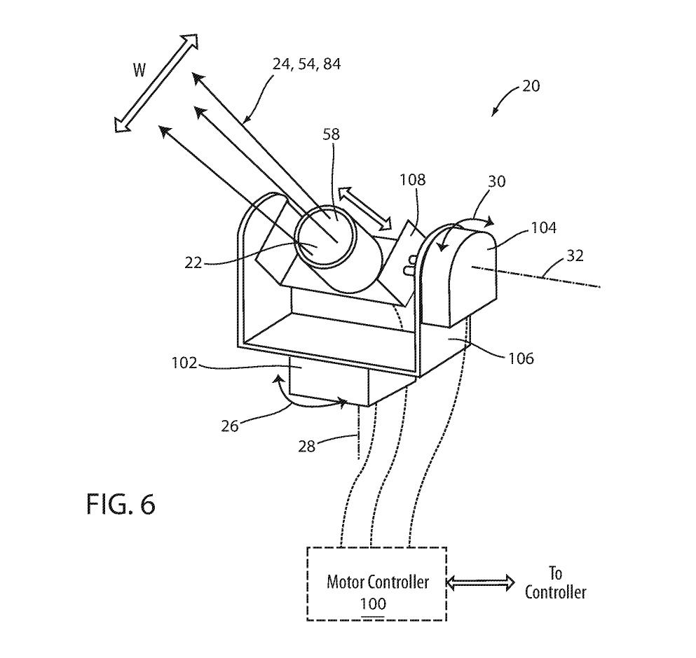

The central location of the lighting apparatus 14 positioned in the headliner 16 may provide for the positioning apparatus 20 to steer the emission 24 in a variety of locations within the passenger compartment 10 or cabin and proximate the vehicle 12. For example, the positioning apparatus 20 may be configured to both rotate 26 the light source 22 about a mounting axis 28 and pivot 30 the light source 22 about a pivot axis 32. The mounting axis 28 may extend substantially normal to a surface of the headliner 16. Additionally, the pivot axis 32 may rotate about the mounting axis 28 and extend substantially perpendicular to the mounting axis 28 (e.g., parallel to the surface of the headliner 16). In this configuration, the positioning apparatus 20 may enable the lighting apparatus 14 to position the light source 22 such that a variety of locations may be illuminated. Further detailed description of the positioning apparatus 20 is provided in reference to FIG. 6.

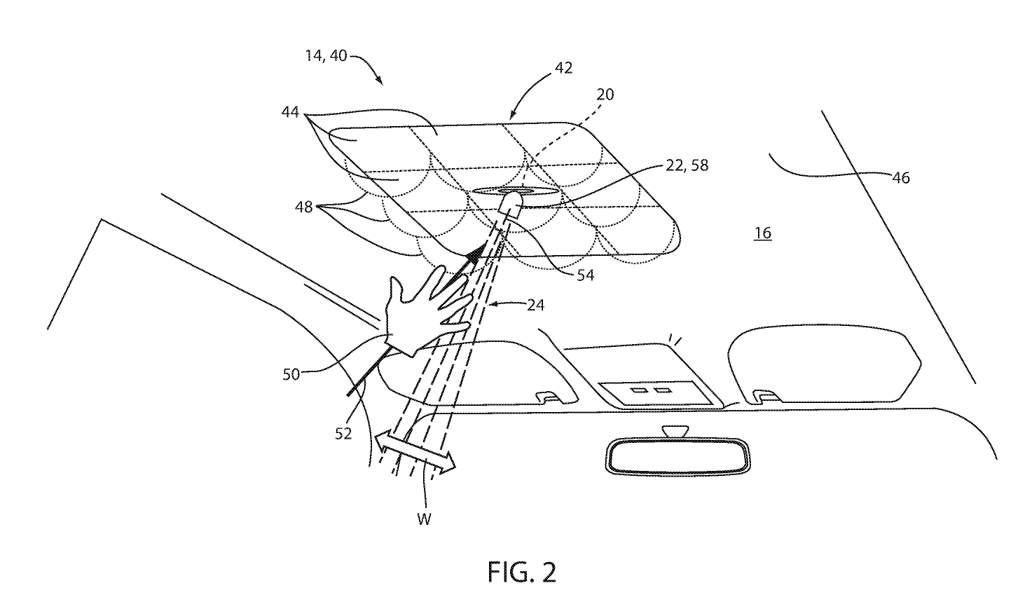

Referring now to FIG. 2, in some embodiments, the lighting apparatus 14 may comprise an object detection sensor 40. The object detection sensor 40 may comprise a sensor array 42 comprising a plurality of proximity sensors 44. The proximity sensors 44 may be implemented as capacitive sensors extending over an interior surface 46 of the headliner 16. Each of the proximity sensors 44 may be configured to generate a detection field 48 extending outward from the interior surface 46. Each of the proximity sensors 44 may be in communication with a controller configured to detect the proximity of an object 50 relative to each of the detection fields 48 and the interior surface 46 of the headliner 16. In this configuration, the controller may be configured to identify a location of the object 50 relative to the light source 22.

Based on the detection of the object 50, the controller may monitor a change in position of the object 50 over time. In this way, the controller may identify one or more gestures or movements of the object 50 and process the gestures or movements to control the position of the light source 22 and the corresponding direction of the lighting emission 24. The object 50 may correspond to an occupant's finger, hand, or other objects that may be moved or controlled by a vehicle passenger. In this configuration, the controller may be configured to identify capacitive changes in the detection fields 48 indicating a presence and proximity of the object 50 among the sensors 44 of the sensor array 42. While the proximity sensors 44 discussed correspond to capacitive sensors, it should be appreciated that additional or alternative types of proximity sensors 44 can be used for detecting various other signal changes, such as, but not limited to, inductive sensors, optical sensors, temperature sensors, resistive sensors, the like, or a combination thereof.

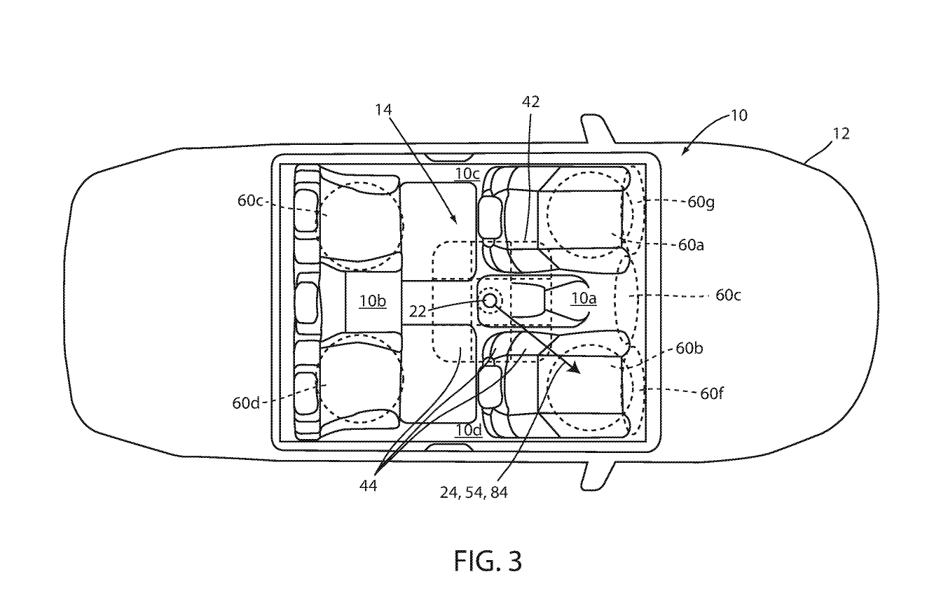

Referring now to FIGS. 1-3, exemplary modes of operation of the lighting apparatus 14 are described in further detail. In operation, the lighting apparatus 14 may operate in a variety of control schemes. Though described individually, each of the control schemes may be utilized alone or in combination to suit a desired operation of the apparatus 14. For example, in some modes of operation, the controller may monitor the sensor array 42 to detect the object 50. Based on a proximity, motion, and/or gesture of the object 50, the controller may control the positioning apparatus 20 to direct the lighting emission 24 based on the movement or relative position of the object 50 relative to each of the sensors 44 of the sensor array 42. In additional modes of operation, the controller may be configured to control the positioning apparatus 20 to direct the lighting emission 24 to illuminate a predetermined location within or proximate the passenger compartment 10. Additionally, the controller may be operable to adjust a beam width W of the lighting emission 24 to adjust a surface area illuminated by the emission 24. Accordingly, the lighting apparatus 14 may provide for a flexible lighting solution to conveniently illuminate a desired portion within or proximate the passenger compartment 10.

In some configurations, the controller may position and control the light source 22 with the positioning apparatus 20 based on a position or motion of the object 50. For example, based on a signal received from one or more of the proximity sensors 44, the controller may identify a position of the object 50 as well as motion and/or gestures detected among the detection fields 48 of the proximity sensors 44. In response to the motion or position of the object 50, the controller may steer or direct the light source 22 to project the lighting emission 24 in a desired direction.

For example, the controller may activate the light source 22 in response to a detection of the object within a first distance threshold of a first proximity sensor 44a. The first proximity sensor 44a may be centrally located and/or located proximate the light source 22 relative to the additional or surrounding proximity sensors 44. The first detection threshold may correspond to a predetermined signal value or voltage level received by the controller from the first proximity sensor 44a. In response to identifying the signal from the first proximity sensor 44a exceeding the first detection threshold, the controller may activate the light source 22.

In addition to activating the light source 22 in response to identifying the signal from the first proximity sensor 44a exceeding the first detection threshold, the controller may further monitor and detect an object direction 52. The object direction 52 may correspond to a direction of approach of the object 50 relative to the light source 22. For example, the object direction 52 may correspond to an approach direction extending from a passenger to the light source 22. The passenger may be positioned in a forward compartment 10a, rear compartment 10b, driver side 10c, passenger side 10d, and/or combinations and intermediate positions therebetween. In this configuration, the controller of the lighting apparatus 14 may activate the light source 22 and control the positioning apparatus 20 to direct the light source 22 toward an origin of the object 50 indicated along the object direction 52 or a seating position of the passenger maneuvering the object 50.

Once the light source 22 is activated and initially positioned by the controller, the controller may continue to monitor the position of the object 50 relative to each of the sensors 44 of the sensor array 42. If the object 50 rapidly disappears from the detection fields 48, the controller may maintain the activation of the light source 22 and control the positioning apparatus 20 to maintain the projection direction 54. If the controller continues to identify the presence of the object 50 within the detection fields 48, the controller may track changes in position and motion of the object 50 to continue to control or maneuver the projection direction 54 of the emission 24 in response to proximity signals from the sensors 44.

For example, in response to identifying that the object 50 is moving from a front 10a, driver-side 10c position toward a front 10a, passenger-side 10d, the controller may respond by pivoting or rotating the positioning apparatus 20 to move the projection direction 54 toward the front 10a, passenger-side 10d. Similarly, in response to identifying that the object 50 is moving from a rear 10b, driver-side 10c position toward a front 10a, driver-side 10c, the controller may respond by pivoting or rotating the positioning apparatus 20 to move the projection direction 54 toward the front 10a, driver-side 10c. In this way, the controller may track the relative position of the object 50 proximate the sensor array 42 of the lighting apparatus 14 to control the projection direction 54 of the emission 24.

In some embodiments, the controller may also be configured to identify one or more gestures of the object 50. Gestures may be identified by changes in position, proximity, and/or apparent size of the object 50. For example, the controller may be operable to detect a pinching or opening/closing motion of the object 50 (e.g., a hand). In response to the detection of the opening or closing, the controller may detect a change in the apparent size of the object 50 in relation to one or more of the detection fields 48. In response to the change in size, the controller may adjust the beam width W of the light source 22 by adjusting a focal lens 58 or selectively activating different emitters of the light source 22. In this way, the controller may identify a gesture to control the beam width W of the emission 24.

Additional gestures that may be identified by the controller may include, but are not limited to, a rotation of the object 50, a twirling or circular motion, an approach or retraction of the object 50 and various other movements. In response to the gestures, the controller may control the lighting apparatus 14 in a variety of ways. For example, the controller may rotate 26 the light source 22 about the mounting axis 28 and/or pivot 30 the light source 22 about a pivot axis 32. Additionally, the controller may be operable to adjust the beam width W in response to one or more gestures identified by the proximity signals from the sensors 44. As described herein, the lighting apparatus 14 may provide for a variety of control inputs that may be configured to control the positioning apparatus 20 and the light source 22 to suit a variety of applications and lighting effects.

In some embodiments, the controller may selectively control the projection direction 54 and/or the beam width W to illuminate a plurality of predetermined locations 60 in the vehicle 12. For example, in response to a proximity detection of the object 50 proximate the first proximity sensor 44a, the controller may identify the signal from the first proximity sensor 44a exceeding the first detection threshold and activate the light source 22. Based on the detection, the controller may further detect the object direction 52 and control the positioning apparatus 20 to direct the emission 24 to illuminate a predetermined location 60 proximate a passenger of the vehicle maneuvering the object 50.

For example, in response to the object direction 52 extending from proximate a driver-seat 60a, the controller may orient the light source 22 to illuminate the front driver seat 60a. The controller may similarly activate the light source to illuminate regions proximate a front passenger seat 60b, a rear drive-side seat 60c, or a rear passenger-side seat 60d. Additional predetermined locations may include, but are not limited to, a center console 60e, glove box 60f, dashboard 60g, door pocket 60h, door handle 60j, etc. In various embodiments, the controller may control the lighting apparatus 14 to selectively illuminate a desired or predetermined location 60 based on the detection of the object 50 corresponding to one or a combination of the detection fields 48.

Additionally, the controller may be configured to detect an access of the center console 60e, glove box 60f, dashboard 60g, door pocket 60h, door handle 60j, or various compartments of the vehicle 12 based on a detection signal. The detection signal may be activated in response to a presence detection or change in a signal from an access switch, proximity sensor, presence sensor or a variety of sensors that may be in communication with the controller. In response to the presence or access detection of the center console 60e or other predetermined locations 60 or portions of the vehicle 12, the controller may orient the light source 22 in the projection direction 54 to illuminate the predetermined location from which the access or presence indication was received. In this way, the lighting apparatus 14 may provide for automated functions to illuminate the predetermined locations 60 in response to a presence or access detection. In such embodiments, the controller may be in communication with a communication bus of the vehicle 12 to send/receive signals to sensors corresponding to the predetermined locations 60 (e.g., an access switch or presence sensor of the center console 60e).

The predetermined locations 60 may be programmed into a memory of the controller and may correspond to a rotational position of one or more motors of the positioning apparatus 20. For example, the positioning apparatus 20 may comprise a first motor and a second motor configured to orient the light source 22 about a plurality of axes. The first motor may be configured to rotate 26 the light source 22 about the mounting axis 28 and the second motor may be configured to pivot 30 the light source 22 about the pivot axis 32. Each of the first motor and the second motor may be operable to monitor a relative or absolute rotational motion and may accordingly be positioned in predetermined angular orientations configured to direct the projection direction 54 to each of the predetermined locations 60. For example, the motors of the positioning apparatus may correspond to servo motors configured to rotate to a selected rotational position in response to a control signal from the controller. In this configuration, the lighting apparatus 14 may be operable to accurately direct the emission 24 in the projection direction 54 to selectively illuminate each of the predetermined locations 60.

The object detection sensor 40 may correspond to a thin structure, which may be disposed behind the headliner 16 on a printed circuit board (PCB), which may correspond to a flexible printed circuit board. In some embodiments, the sensor array 42 comprises a plurality of proximity sensors 44, which may correspond to capacitive pads adhered to or printed on the headliner 16. The capacitive pads may be substantially transparent and printed on a surface of the headliner 16 in a conductive material. The conductive material may correspond to copper, indium tin oxide (ITO), or other conductive materials. In this configuration, the object sensor 40 may be implemented as a thin layer of conductive material incorporated with or disposed on the headliner 16.

For example, each of the proximity sensors 44 may correspond to capacitive pads printed on the outer surface of the headliner 16, facing inward into the passenger compartment 10. The proximity sensors 44 may similarly be printed and/or disposed on a back surface of the headliner 16 facing outward, away from the passenger compartment 10. In this configuration, each of the proximity sensors 44 may be configured to generate a detection field 48 extending into the passenger compartment 10. The detection of the object 50 may be communicated via proximity signals from each of the sensors 44 such that the controller is operable to identify a location of the object 50 in relation to the locations of the sensors 44.

The light source 22 may correspond to a variety of light sources or emitters. Additionally, the light source 22 may also be referred to as an excitation source and may be operable to emit the lighting emission 24. The light source 22 may comprise any form of light source, for example, halogen lighting, fluorescent lighting, light emitting diodes (LEDs), organic LEDs (OLEDs), polymer LEDs (PLEDs), solid state lighting, or any other form of lighting configured to output the lighting emission 24. The lighting apparatus 14 may additionally comprise a focal lens 58 configured to control the beam width W of the lighting emission 24. The focal lens 58 may be configured to adjust the beam width by adjusting a space between the light source 22 and the lens 58. Such a positioning operation of the lens 58 may be controlled by a motorized lens positioning apparatus 20 controlled by the controller.

In some embodiments, the light source 22 may comprise a plurality for light sources forming a lighting array. In this configuration, the controller may adjust the beam width W by selectively activating individual light sources of the lighting array. Each of the light sources may be positioned in relation to the lens 58 such that the beam width W is adjusted in response to the activation of each of the light sources. Based on the various configurations discussed herein, the lighting apparatus 14 may be operable to adjust a projection direction 54 and beam width W to illuminate a variety of predetermined locations 60 or surfaces within or proximate to the passenger compartment 10.

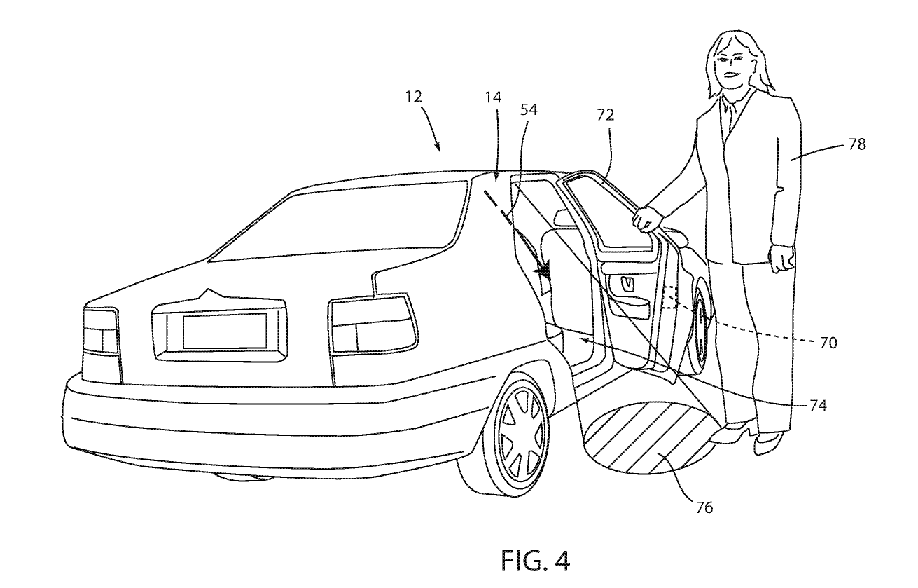

Referring now to FIG. 4, an access light configuration of a lighting apparatus 14 is shown. In addition to activating in response to the access or presence detection signals of the center console 60e, glove box 60f, dashboard 60g, door pocket 60h, the controller may also be in communication with one or more passenger door sensors 70. In response to an indication that a door 72 is ajar communicated from the door sensor 70, the controller may access a predetermined locations 60 of the lighting apparatus 14 to illuminate an opening 74 of the door 72. As discussed previously, the predetermined locations 60 may correspond to an angular position of the first motor 102 and the second motor 104 configured to direct the lighting emission 24 such that the projection direction 54 is directed toward the opening 74.

In some embodiments, the lighting apparatus 14 may be operable to illuminate a ground surface 76 proximate the opening 74 of the door 72. In this configuration, the lighting emission 24 may be emitted from the light source 22 positioned on the headliner 16 such that the emission 24 passes through the opening and illuminates a portion of the ground surface 76 to provide access lighting for a passenger 78. As such, the lighting apparatus 14 may be configured to illuminate a portion of the environment proximate the vehicle 12 in response to the controller identifying that the door 72 of the vehicle 12 is opened. Though demonstrated and discussed in reference to the passenger door 72, the door sensor 70 may be implemented in one or more of the vehicle doors. Accordingly, the controller may be configured to access different predetermined positions in memory to orient the light source 22 with the positioning apparatus 20 to illuminate the opening 74 of each of the vehicle doors 72.

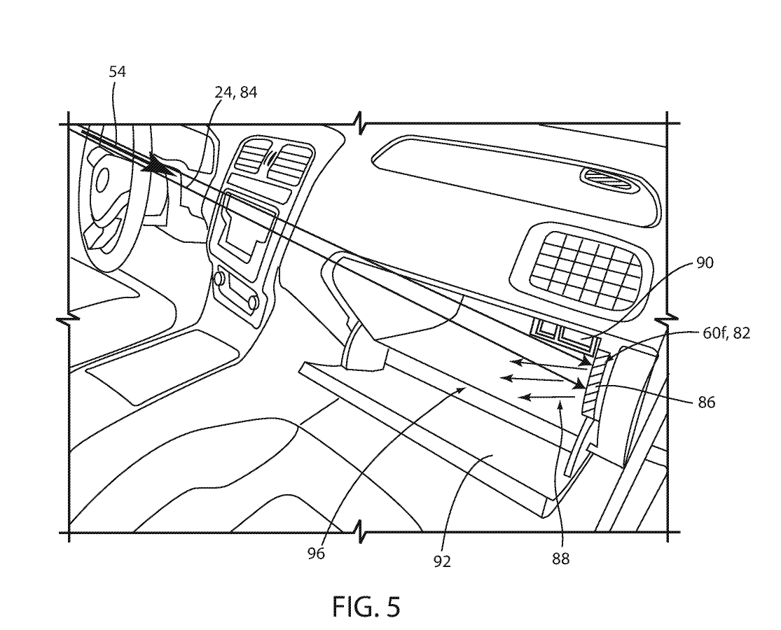

Referring now to FIG. 5, an exemplary embodiment of the lighting apparatus 14 is shown. As discussed previously, in some embodiments, the lighting apparatus 14 may be configured to illuminate a predetermined location 60 or surface 82 of the vehicle 12. As shown in FIG. 5, a glove box 60f of the vehicle 12 may be illuminated by the light source 22. The light source 22 may be configured to emit the lighting emission 24 and, in some embodiments, may similarly be operable to emit an excitation emission 84. The excitation emission 84 may correspond to a wavelength of light configured to excited a photoluminescent portion 86, which may be disposed proximate the predetermined location 60. In this configuration, the photoluminescent portion 86 may emit a luminescent emission 88 in response to the excitation emission 84 impinging upon the photoluminescent portion 86. Though discussed in reference to the glove box 60f, the photoluminescent portion 86 may be disposed on any of the surfaces, compartments, or predetermined locations 60 as discussed herein and operate to illuminate the vehicle 12 as discussed herein.

In operation, the lighting apparatus 14 may illuminate the photoluminescent portion 86 similarly to any of the predetermined locations 60 or portions of the vehicle 12. For example, the controller may be in communication with an access detection switch 90 or access detection sensor, which may be disposed in or proximate to an access door 92 of the glove box 60f. The detection switch 90 may correspond to a presence detection sensor (e.g., resistive, capacitive, etc.) or an electromechanical switch configured to detect an object proximate thereto or the opening 72 of the access door 90. In response to a communication to the controller from the detection switch 90 indicating that the access door 92 is ajar, the controller may control the positioning apparatus 20 to direct the projection direction 54 toward a predetermined location identified in the memory for the glove box 60f. The controller may then access the predetermined location and control the positioning apparatus 20 to direct the projection direction 54 toward the photoluminescent portion 86.

Once the controller has executed the positioning of the lighting apparatus 14 toward the photoluminescent portion 86, the controller may activate the excitation emission 84 to excite the photoluminescent material of the photoluminescent portion 86. The excitation emission 84 may be emitted from the light source 22 similar to the lighting emission 24. Accordingly, the light source 22 may comprise a light source configured to emit the excitation emission 84 comprising a wavelength of light within an absorption range of one or more photoluminescent materials of the photoluminescent portion 86. In response to receiving the excitation emission 84, the photoluminescent material of the photoluminescent portion 86 may be excited and output the luminescent emission 88 in a color different from the excitation emission 84.

For example, in some embodiments, the excitation emission 84 may comprise a first wavelength of light in a first range of wavelengths. The first wavelength may correspond to a wavelength in the blue spectral color range and comprises a range of wavelengths generally expressed as blue light (˜440-500 nm). In some implementations, the first wavelength may also comprise wavelengths in a near ultraviolet color range (˜390-450 nm). In response to receiving the excitation emission 84, the photoluminescent portion 86 may emit the luminescent emission 88 in a second range of wavelengths. The second range of wavelengths may differ from the first range of wavelengths and may include wavelengths ranging from approximately 450-900 nm. Such wavelengths may be emitted from one or more photoluminescent materials configured to emit light substantially in the red, green, and blue color ranges. In an exemplary embodiment, the luminescent emission 88 may correspond to a combination of the red, green, and blue color ranges configured to emit a substantially white light to illuminate an interior of a cavity 96 formed by the glove box 60f.

In order to provide for the excitation emission 84 to be emitted from the light source 22, the lighting apparatus 14 may comprise a plurality of light sources. The light sources may comprise any form of light source, for example, halogen lighting, fluorescent lighting, light emitting diodes (LEDs), organic LEDs (OLEDs), polymer LEDs (PLEDs), solid state lighting or any other form of lighting. The light sources 22 may comprise a first light source or first group of emitters configured to emit the lighting emission 24. Additionally, the light source 22 may comprise a second light source or second group of emitters configured to emit the excitation emission 84. In this configuration, the controller of the lighting apparatus 14 may be operable to selectively activate the lighting emission 24 to illuminate a portion of the vehicle 12 and selectively activate the excitation emission 84 to excite the photoluminescent portion 86 to output the luminescent emission 88. Accordingly, the lighting apparatus 14 may be configured to suit a variety of lighting applications without departing from the spirit of the disclosure.

Referring now to FIG. 6, an exemplary embodiment of the positioning device 20 is shown. The positioning apparatus 20 may be configured to direct the lighting emission 24 and/or the excitation emission 84 from the light source 22 to illuminate a variety of locations within or proximate to the passenger compartment 10. As discussed previously, the lighting apparatus 14 may be positioned in the headliner 16 and be configured to control the projection direction 54 to illuminate a variety of locations based on control signals from a motor controller 100 in communication with or incorporated as part of the controller of the lighting apparatus 14.

In an exemplary embodiment, the positioning apparatus 20 may be configured to both rotate 26 the light source 22 about the mounting axis 28 and pivot 30 the light source 22 about the pivot axis 32. The mounting axis 28 may extend substantially normal to the interior surface 46 of the headliner 16. Additionally, the pivot axis 32 may rotate about the mounting axis 28 and extend substantially perpendicular to the mounting axis 28 (e.g., parallel to the surface of the headliner 16). In this configuration, the positioning apparatus 20 may enable the lighting apparatus 14 to position the light source 22 such that a variety of locations may be illuminated.

The predetermined locations 60 may be programmed into a memory of the controller and may correspond to a rotational position of one or more motors of the positioning apparatus 20. For example, the positioning apparatus 20 may comprise a first motor 102 and a second motor 104. The first motor 102 may be configured to rotate 26 the light source 22 about the mounting axis 28 and the second motor 104 may be configured to pivot 30 the light source 22 about the pivot axis 32. Each of the first motor 102 and the second motor 104 may be operable to monitor a relative or absolute rotational motion and may accordingly be positioned in predetermined angular orientations configured to direct the projection direction 54 to each of the predetermined locations 60. In some embodiments, the motors 102, 104 of the positioning apparatus 20 may correspond to servo motors configured to rotate to a selected rotational position in response to a control signal from the controller. In this configuration, the positioning apparatus 20 may be operable to accurately direct the emissions 24, 84 in the projection direction 54 to selectively illuminate each of the predetermined locations 60.

The first motor 102 and the second motor 104 may engage the light source 22 of the lighting apparatus 14 via a rotational bracket 106 and a pivotal bracket 108. The first motor 102 may engage the rotational bracket 106 such that the lighting apparatus 14 may rotate 360 degrees to illuminate a desired portion of the vehicle 12. The pivotal bracket 108 may be secured to the rotational bracket 106 and rotate in response to movement of the first motor 102. The pivotal bracket 108 may further be connected to the second motor 104 and pivot approximately 180 degrees within the rotational bracket 106. In this configuration, the positioning apparatus 20 may be configured to rotate and pivot the light source 22 to illuminate a desired portion of the vehicle 12.

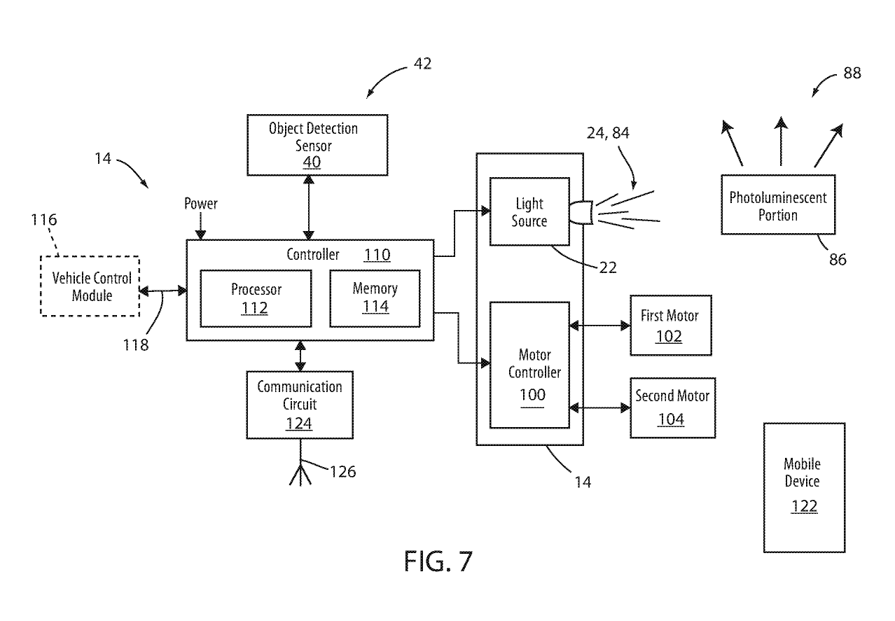

Referring now to FIG. 7, a block diagram of the lighting apparatus 14 demonstrating the controller 110 is shown. The apparatus 14 may comprise a controller 110, which may comprise a processor 112. The processor 112 may correspond to one or more circuits configured to receive signals and information from a variety of vehicle systems, peripherals, and systems discussed herein. The processor 112 may correspond to one or more microprocessors, circuits, application specific integrated circuits (ASIC), microprocessors, and/or related processing devices. The processor 112 may be in communication with a memory 114. The memory 114 may correspond to random access memory (RAM), read only memory (ROM), magnetic disc storage media, optical storage media, flash memory devices, etc. In various embodiments, the memory 114 may be configured to store machine readable information or routines to enable various processes and methods disclosed herein.

As discussed herein, the controller 110 may be in communication with an object detection sensor 40. The object detection 40 sensor may comprise the sensor array 42 comprising the plurality of proximity sensors 44. The proximity sensors 44 may be implemented as capacitive sensors extending over an interior surface 46 of the headliner 16. Each of the proximity sensors 44 may be in communication with the controller 110. Accordingly, the controller 110 may be configured to detect the proximity of the object 50 relative to each of the detection fields 48 and the interior surface 46 of the headliner 16. In this configuration, the controller 110 may be configured to identify a relative location of the object 50 relative to the light source 22.

The controller 110 may further be in communication with a vehicle control module 116 via a communication bus 118. In this way, the controller 110 may be configured to receive various signals or indications of vehicle status conditions including, but not limited to, a gear selection (e.g., park, drive, etc.), a vehicle speed, an engine status, a fuel warning, and various other vehicle conditions. The controller 110 may further be in communication with a variety of vehicle sensors configured to communicate various conditions of systems or devices related to the operation of the vehicle 12. For example, the controller 110 may be in communication with an access switch, proximity sensor, presence sensor or a variety of sensors that may be configured to communicate a presence detection or status of one or more consoles or storage compartments of the vehicle. In this configuration, the controller 110 may identify the status (e.g., presence detection, ajar status, etc.) of the center console 60e, glove box 60f, dashboard 60g, door pocket 60h, door handle 60j, or various compartments of the vehicle 12 based on a detection signal and control the lighting apparatus 14 to illuminate a corresponding predetermined location 60 identified in the memory 114.

The controller 110 may be in communication with the motor controller 100 configured to control the projection direction 54 to illuminate a variety of locations in the vehicle 12. The motor controller 100 may control the motors 102 and 104 based on control signals from the controller 110. For example, the motor controller 100 may be in communication with a first motor 102 and a second motor 104. The first motor 102 may be configured to rotate 26 the light source 22 about the mounting axis 28 and the second motor 104 may be configured to pivot 30 the light source 22 about the pivot axis 32. Each of the first motor 102 and the second motor 104 may be operable to monitor a relative or absolute rotational motion and may accordingly be positioned in predetermined angular orientations configured to direct the projection direction 54 to each of the predetermined locations 60. In some embodiments, the motors 102, 104 of the positioning apparatus 20 may correspond to servo motors configured to rotate to a selected rotational position in response to a control signal from the controller. In this configuration, the lighting apparatus 14 may be operable to accurately direct the emissions 24, 84 in the projection direction 54 to selectively illuminate each of the predetermined locations 60.

In some embodiments, the controller 110 may further be configured to identify a passenger location in in the vehicle based on a signal from a mobile device 122. For example, the controller 110 may comprise a communication circuit 124 configured to communicate and detect one or more signals from the mobile device 122. The communication circuit 124 may correspond to a transceiver circuit comprising a directional antenna 126. The communication circuit 124 may receive signals via the directional antenna 126 from the mobile device 122 and thereby identify a direction from which the signals were sent. In this configuration, the controller may be configured to selectively activate the light source 22 and direct the projection direction 54 toward the direction from which the signals were sent. Accordingly, the controller 110 may be configured to identify an approximate location of the mobile device 122 and control the lighting apparatus 14 to illuminate a portion of the vehicle 12 proximate a location of the mobile device 122.

The controller 110 may communicate with the mobile device 122 via communication circuit 124 by utilizing a variety of communication protocols. For example, the communication circuit 124 may operate based on one or more protocols including, but not limited to, Zigbee, WiMAX, Wi-Fi, Bluetooth, Bluetooth Low Energy (BLE) and/or cellular protocols (e.g., GSM, CDMA, LTE, etc.). In this configuration, the controller 110 may be operable to communicate with the mobile device 122 and identify a relative location of the mobile device 122 to automatically position the lighting apparatus 14 to illuminate an area proximate the mobile device 122.

The disclosure provides for a variety of systems and configurations that may be utilized to illuminate a portion of a vehicle 12. Though a variety of specific exemplary systems are described, the beneficial systems provided herein may be combined in a variety of ways to suit a particular application for a vehicle or various other systems. Accordingly, it is to be understood that variations and modifications can be made to the aforementioned structures without departing from the concepts of the present disclosure, and further it is to be understood that such concepts are intended to be covered by the following claims unless these claims by their language expressly state otherwise.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A vehicle lighting apparatus comprising:
a positioning apparatus configured to provide multi axis motion;
a light source configured to output an emission in connection with the apparatus;
a light controller in communication with the positioning apparatus and the light source, wherein the light controller is configured to control the positioning apparatus to orient the light source directing the emission to a location in the vehicle.

2. The lighting apparatus according to claim 1, wherein the positioning apparatus comprises at least one motor.

3. The lighting apparatus according to claim 2, wherein the at least one motor is configured to adjust the orientation of the light source about a plurality of axes.

4. The lighting apparatus according to claim 2, wherein the at least one motor comprises a servo motor.

5. The lighting apparatus according to claim 1, further comprising a motor controller configured to control the positioning apparatus orienting the light source directing the emission to a plurality of predetermined locations in the vehicle.

6. The lighting apparatus according to claim 5, wherein at least one of the predetermined locations comprises a photoluminescent portion.

7. The lighting apparatus according to claim 6, wherein the emission comprises a wavelength of light configured to excite the photoluminescent portion.

8. The lighting apparatus according to claim 1, further comprising:
an access detection sensor configured to detect an access of a compartment within the vehicle.

9. The lighting apparatus according to claim 8, wherein the light controller is further configured to:
control the positioning apparatus orienting the light source to a predetermined location based on the detection of the access by the access detection sensor.

10. The lighting apparatus according to claim 9, wherein the predetermined location is located in a passenger cabin of the vehicle proximate the access detection sensor.

11. The lighting apparatus according to claim 1, further comprising an object detection sensor disposed on a vehicle headliner proximate the light source and the positioning apparatus.

12. The lighting apparatus according to claim 11, wherein the object detection sensor comprises a capacitive sensor array disposed over a surface of the headliner of the vehicle.

13. The lighting apparatus according to claim 11, wherein the object detection sensor comprises a capacitive sensor array comprising a plurality of detection fields distributed around the light source.

14. The lighting apparatus according to claim 12, wherein the object detection sensor is configured to output a directional signal indicating a rotational direction of the object about the light source.

15. The lighting apparatus according to claim 14, wherein the controller is further operable to:
control the positioning apparatus directing the emission in the rotational direction in response to receiving the directional signal.

16. The lighting apparatus according to claim 13, wherein the object detection sensor is operable to output a detection signal indicating a motion of the object among the plurality of detection zones of the sensor array.

17. The lighting apparatus according to claim 16, wherein the controller is further operable to identify a motion and direction of the object based on the detection signal indicating the motion, wherein the controller is further operable to control the positioning apparatus to adjust a direction of the emission according to the motion and the direction.

18. The lighting apparatus according to claim 16, wherein the controller is further configured to:
identify a gesture in response to the motion of the object.

19. The lighting apparatus according to claim 18, wherein the controller is further configured to:
control a beam width of the emission in response to the gesture.

20. A vehicle lighting apparatus comprising:
a positioning apparatus comprising at least one motor configured to provide multi axis motion;
a light source configured to output a directional emission in connection with the positioning apparatus;
a controller in communication with the positioning apparatus and the light source, wherein the controller is configured to control the positioning apparatus orienting the light source and directing the emission to a location in the vehicle.
